(19) United States
(12) Patent Application Publication
(10) Pub. No.: US 2019/0355354 A1
(43) Pub. Date: Nov. 21, 2019

(54) METHOD, APPARATUS AND SYSTEM FOR SPEECH INTERACTION

(71) Applicant: Baidu Online Network Technology (Beijing) Co., Ltd ., Beijing (CN)

(72) Inventor: Lei Geng, Beijing (CN)

(21) Appl. No.: 16/235,768

(22) Filed: Dec. 28, 2018

(30) Foreign Application Priority Data
May 21, 2018 (CN) 201810489153.5

(51) Int. Cl. G10L 15/22; G10L 21/0272; G10L 21/0208; G10L 15/20; G06F 3/16

(52) U.S. Cl. CPC G10L 15/22; G10L 21/0272; G10L 2015/223; G10L 15/20; G06F 3/167; G10L 21/0208

(57) ABSTRACT

A method, apparatus, and system for speech interaction are provided according to the embodiments. A specific implementation of the method includes: generating a speech input signal based on an input sound, the input sound including a user voice and an ambient sound; performing noise reduction processing on the speech input signal to extract a target speech signal sent by a user; and sending the target speech signal to a target speech processing terminal, the target speech processing terminal analyzing the target speech signal to obtain an analysis result, and performing an operation related to the analysis result. This embodiment may improve the noise reduction rate for the speech signal and further improve the accuracy of the operation execution.

### CROSS-REFERENCE TO RELATED APPLICATIONS

This application claims priority to Chinese Patent Application No. 201810489153.5, filed on May 21, 2018, titled “Method, Apparatus and System for Speech Interaction,” which is hereby incorporated by reference in its entirety.

### TECHNICAL FIELD

Embodiments of the present disclosure relate to the field of computer technology, and specifically to a method, apparatus, and system for speech interaction.

### BACKGROUND

At present, with the rapid popularization of smart speech interaction technology, more and more users use speech interaction devices, and the speech interaction technology brings great convenience to the users' lives. In some scenarios (for example, in an outdoor environment or during moving of a user), noise signals generated by the speech interaction devices themselves generally cause strong interference to the speech signals sent by the users, and how to perform noise reduction processing on the speech signals is of great significance for the speech interaction devices.

### SUMMARY

Embodiments of the present disclosure provide a method, apparatus, and system for speech interaction.

In a first aspect, the embodiments of the present disclosure provide a method for speech interaction, including: generating a speech input signal based on an input sound, the input sound including a user voice and an ambient sound; performing noise reduction processing on the speech input signal to extract a target speech signal sent by a user; and sending the target speech signal to a target speech processing terminal, the target speech processing terminal analyzing the target speech signal to obtain an analysis result, and performing an operation related to the analysis result.

In some embodiments, the generating a speech input signal based on an input sound includes: converting the input sound into an audio signal; and sampling the audio signal at a preset first sampling rate to obtain the speech input signal.

In some embodiments, the performing noise reduction processing on the speech input signal to extract a target speech signal sent by a user, includes: performing beamforming processing on the speech input signal to obtain a composite signal; performing noise suppression processing on the composite signal; and performing de-reverberation processing and speech enhancement processing on the signal to which the noise suppression processing is performed to obtain the target speech signal sent by the user.

In some embodiments, before the generating a speech input signal based on an input sound, the method further includes: establishing a pairing relationship with the target speech processing terminal, in response to receiving a pairing request sent by the target speech processing terminal.

In a second aspect, the embodiments of the present disclosure provide an apparatus for speech interaction, including: a generation unit, configured to generate a speech input signal based on an input sound, the input sound including a user voice and an ambient sound; a noise reduction unit, configured to perform noise reduction processing on the speech input signal to extract a target speech signal sent by a user; and a sending unit, configured to send the target speech signal to a target speech processing terminal, the target speech processing terminal analyzing the target speech signal to obtain an analysis result, and performing an operation related to the analysis result.

In some embodiments, the generation unit is further configured to generate a speech input signal based on an input sound by: converting the input sound into an audio signal; and sampling the audio signal at a preset first sampling rate to obtain the speech input signal.

In some embodiments, the noise reduction unit is further configured to perform noise reduction processing on the speech input signal to extract a target speech signal sent by a user by: performing beamforming processing on the speech input signal to obtain a composite signal; performing noise suppression processing on the composite signal; and performing de-reverberation processing and speech enhancement processing on the signal to which the noise suppression processing is performed to obtain the target speech signal sent by the user.

In some embodiments, the apparatus further includes: an establishing unit, configured to establish a pairing relationship with the target speech processing terminal, in response to receiving a pairing request sent by the target speech processing terminal.

In a third aspect, the embodiments of the present disclosure provide a method for speech interaction, including: receiving a target speech signal sent by a noise reduction headset, the target speech signal being a speech signal sent by a user and extracted by the noise reduction headset through performing noise reduction processing on a speech input signal, and the speech input signal being generated based on an input sound; analyzing the target speech signal to obtain an analysis result; and performing an operation related to the analysis result.

In some embodiments, the performing an operation related to the analysis result, includes: sending a control command to a command execution device indicated by a device identifier for the command execution device to perform an operation related to the control command, in response to determining that the analysis result includes the device identifier of the command execution device and the control command for the command execution device.

In a fourth aspect, the embodiments of the present disclosure provide an apparatus for speech interaction, including: a receiving unit, configured to receive a target speech signal sent by a noise reduction headset, the target speech signal being a speech signal sent by a user and extracted by the noise reduction headset through performing noise reduction processing on a speech input signal, and the speech input signal being generated based on an input sound; an analyzing unit, configured to analyze the target speech signal to obtain an analysis result; and a performing unit, configured to perform an operation related to the analysis result.

In some embodiments, the performing unit is further configured to perform an operation related to the analysis result by: sending a control command to a command execution device indicated by a device identifier for the command execution device to perform an operation related to the control command, in response to determining that the analysis result includes the device identifier of the command execution device and the control command for the command execution device.

In a fifth aspect, the embodiments of the present disclosure provide a system for speech interaction, including a speech processing terminal and a noise reduction headset, the system including: the noise reduction headset, configured to generate a speech input signal based on an input sound, perform noise reduction processing on the speech input signal to extract a target speech signal sent by a user, and send the target speech signal to the speech processing terminal, the input sound including a user voice and an ambient sound; and the speech processing terminal, configured to analyze the target speech signal to obtain an analysis result, and perform an operation related to the analysis result.

In some embodiments, the noise reduction headset is configured to convert the input sound into an audio signal, and sample the audio signal at a preset first sampling rate to obtain the speech input signal.

In some embodiments, the noise reduction headset, is configured to perform beamforming processing on the speech input signal to obtain a composite signal, perform noise suppression processing on the composite signal, and perform de-reverberation processing and speech enhancement processing on the signal to which the noise suppression processing is performed to obtain the target speech signal sent by the user.

In some embodiments, the speech processing terminal is configured to send a pairing request to the noise reduction headset; and the noise reduction headset, is configured to establish a pairing relationship with the speech processing terminal.

In some embodiments, the system further includes a command execution device; the speech processing terminal, is configured to send a control command to a command execution device, in response to determining that the analysis result includes a device identifier of the command execution device and a control command for the command execution device; and the command execution device, is configured to perform an operation related to the control command.

In a sixth aspect, the embodiments of the present disclosure provide a noise reduction headset, including: one or more processors; and a memory, storing one or more programs thereon, the one or more programs, when executed by the one or more processors, cause the one or more processors to implement the method for speech interaction according to any one of the embodiments.

In a seventh aspect, the embodiments of the present disclosure provide a speech processing terminal, including: one or more processors; and a memory, storing one or more programs thereon, the one or more programs, when executed by the one or more processors, cause the one or more processors to implement the method for speech interaction according to any one of the embodiments.

In an eighth aspect, the embodiments of the present disclosure provide a computer readable medium, storing a computer program thereon, the computer program, when executed by a processor, implements the method for speech interaction according to any one of the embodiments.

In a ninth aspect, the embodiments of the present disclosure provide a computer readable medium, storing a computer program thereon, the computer program, when executed by a processor, implements the method for speech interaction according to any one of the embodiments.

In the method, apparatus, and system for speech interaction provided by the embodiments of the present disclosure, first, the noise reduction headset is configured to generate a speech input signal based on an input sound, then perform noise reduction processing on the speech input signal to extract a target speech signal sent by a user, and send the target speech signal to the speech processing terminal, the speech processing terminal is configured to analyze the target speech signal to obtain an analysis result, and perform an operation related to the analysis result. Therefore, the generated speech signal may be denoised at the noise reduction headset end to extract the target speech signal sent by the user, and the target speech signal is sent to the speech processing terminal for analysis to perform a corresponding operation. This method for speech interaction may improve the noise reduction rate for the speech signal and further improve the accuracy of the operation execution.

### BRIEF DESCRIPTION OF THE DRAWINGS

After reading detailed descriptions of non-limiting embodiments with reference to the following accompanying drawings, other features, objectives and advantages of the present disclosure will become more apparent:

FIG. 1 is an exemplary system architecture diagram to which the present disclosure is applicable;

FIG. 2 is a flowchart of an embodiment of a method for speech interaction according to the present disclosure;

FIG. 3 is a schematic diagram of an application scenario of the method for speech interaction according to the present disclosure;

FIG. 4 is a flowchart of another embodiment of a method for speech interaction according to the present disclosure;

FIG. 5 is a flowchart of another embodiment of the method for speech interaction according to the present disclosure;

FIG. 6 is a timing diagram of an embodiment of a system for speech interaction according to the present disclosure;

FIG. 7 is a schematic structural diagram of an embodiment of an apparatus for speech interaction according to the present disclosure;

FIG. 8 is a schematic structural diagram of another embodiment of an apparatus for speech interaction according to the present disclosure; and

FIG. 9 is a schematic structural diagram of a computer system adapted to implement a noise reduction headset of the embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

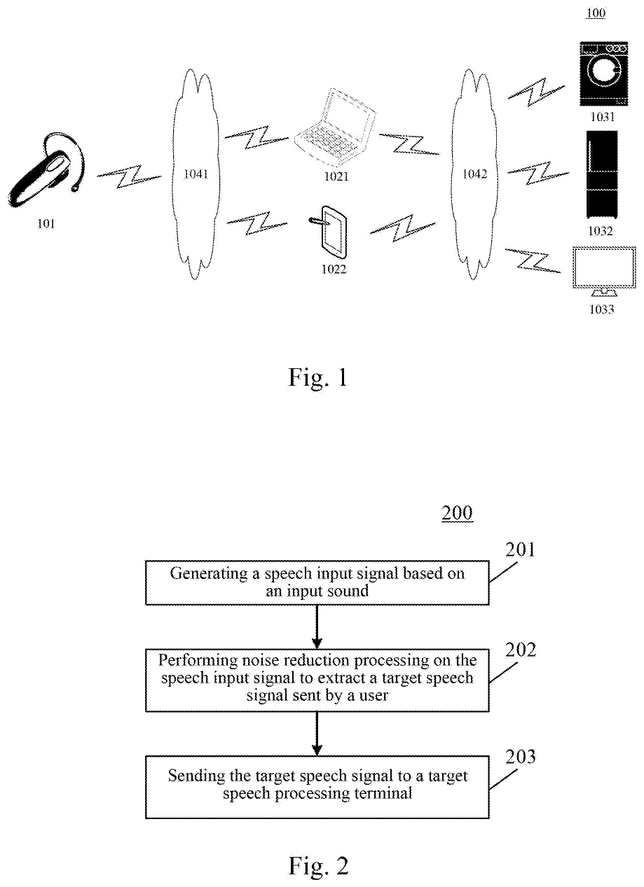

FIG. 1 shows an exemplary system architecture 100 of an embodiment of a method for speech interaction or apparatus for speech interaction or system for speech interaction to which the present disclosure is applicable.

As shown in FIG. 1, the system architecture 100 may include a noise reduction headset 101, speech processing terminals 1021, 1022, command execution terminals 1031, 1032, 1033, and networks 1041, 1042. The network 1041 is configured to provide a communication link medium between the noise reduction headset 101 and the speech processing terminals 1021, 1022; the network 1042 is configured to provide a communication link medium between the speech processing terminals 1021, 1022 and the command execution terminals 1031, 1032, and 1033. The networks 1041, 1042 may include various connection types, such as wired, wireless communication links, or fiber optic cables.

A user may interact with the speech processing terminals 1021, 1022 through the network 1041 using the noise reduction headset 101 to send or receive messages and the like. For example, a speech input signal may be generated based on an input sound, and noise reduction processing may be performed on the generated speech input signal to extract a target speech signal sent by the user, and then the target speech signal is sent to the speech processing terminals 1021, 1022.

The command execution terminals 1031, 1032, and 1033 may be various electronic devices capable of receiving control commands sent by the speech processing terminals 1021, 1022 and capable of performing operations indicated by the control commands, including but not limited to televisions, speakers, sweeping robots, smart washing machines, smart refrigerators, smart ceiling lamps, curtains, air conditioners, security devices, and the like.

The speech processing terminals 1021, 1022 may be various electronic devices that analyze speech signals. The speech processing terminals 1021 and 1022 may receive the target speech signal sent by the noise reduction headset 101, then analyze the target speech signal to obtain an analysis result, and then perform an operation related to the analysis result.

The speech processing terminals 1021, 1022 may be hardware or software. The speech processing terminals 1021, 1022 being hardware may be various electronic devices that support information interaction, including but not limited to smart phones, tablets, smart watches, e-book readers, MP3 players (Moving Picture Experts Group Audio Layer III), MP4 (Moving Picture Experts Group Audio Layer IV) players, laptop portable computers, desktop computers, and the like. The speech processing terminals 1021, 1022 being software may be installed in the above-listed electronic devices. The speech processing terminals may be implemented as software programs or software modules, or may be implemented as a single software program or single software module, which is not specifically limited in the present disclosure.

It should be noted that the method for speech interaction provided by the embodiments of the present disclosure may be executed by the noise reduction headset 101. Here, an apparatus for speech interaction may be disposed in the noise reduction headset 101. The method for speech interaction may also be performed by the speech processing terminals 1021 and 1022. In this case, the apparatus for speech interaction may also be disposed in the speech processing terminals 1021 and 1022.

It should be appreciated that the numbers of the noise reduction headset, the speech processing terminals, the command execution terminals and the networks in FIG. 1 are merely illustrative. Any number of noise reduction headsets, speech processing terminals, command execution terminals and networks may be provided based on the actual requirements.

With further reference to FIG. 2, a flow 200 of an embodiment of a method for speech interaction according to the present disclosure is illustrated. The method for speech interaction includes steps 201 to 203.

Step 201 includes generating a speech input signal based on an input sound.

In the present embodiment, an execution body of the method for speech interaction (for example, the noise reduction headset as shown in FIG. 1) may generate the speech input signal based on the input sound. Sound generally refers to sound waves generated by vibration of an object. The above input sound may be currently acquired sound, may include a user voice and an ambient sound, and the ambient sound is generally noise. When the input sound is transmitted to the vicinity of the execution body, the vibrating diaphragm in the microphone of the execution body vibrates along with the sound waves, and the vibration of the vibrating diaphragm move the magnet inside to form a varying current, thereby generating an analog electric signal. The generated analog electric signal is an audio signal. The audio signal refers to an information carrier for a frequency and amplitude change of regular sound waves with speech, music and sound effects. Then, the execution body may perform sampling processing on the audio signal to obtain the speech input signal.

In some alternative implementations of the present embodiment, the execution body may convert the input sound into an audio signal. The vibrating diaphragm in the microphone of the execution body vibrates along with the sound waves, and the vibration of the vibrating diaphragm moves the magnet inside to form a varying current, thereby generating an analog electric signal, and the generated analog electric signal is the audio signal; then, the execution body may sample the audio signal at a preset first sampling rate to obtain the speech input signal. The sampling rate, also known as the sampling speed or sampling frequency, defines the number of samples that are extracted from a continuous signal and form discrete signals per second. Since the obtained speech input signal needs to be sent to a target speech processing terminal for processing such as speech recognition, and the target speech processing terminal generally has a good speech recognition effect by performing the speech recognition on the digital signal obtained by sampling at a sampling rate of 16 kilohertz (kHz). The first sampling rate may be generally set as 16 kHz, or may be set as other sampling rates at which a predetermined speech recognition effect can be achieved.

In some alternative implementations of the present embodiment, the execution body may receive a pairing request of the speech processing terminal, and if the pairing request of the speech processing terminal is received, a pairing relationship with the target speech processing terminal may be established. The speech processing terminal that establishes the pairing relationship with the execution body may be determined as the target speech processing terminal. After the pairing is successful, the execution body may become a microphone peripheral of the target speech processing terminal.

Step 202 includes performing noise reduction processing on the speech input signal to extract a target speech signal sent by a user.

In the present embodiment, the execution body may perform the noise reduction processing on the speech input signal generated in step 201 to extract the target speech signal sent by the user. The execution body may use a commonly used digital filter, for example, FIR (Finite Impulse Response), IIR (Infinite Impulse Response), etc., to perform noise reduction processing on the speech input signal to extract the target speech signal sent by the user.

In some alternative implementations of the present embodiment, a microphone array may be installed in the execution body. The microphone array is generally a system composed of a certain number of acoustic sensors (generally microphones) for sampling and processing spatial characteristics of the sound field. The use of the microphone array for the acquisition of the speech signal may utilize the difference between the phases of sound waves received by a plurality of microphones to filter the sound waves, thereby maximally removing the ambient background sound to achieve the effect of noise reduction. The execution body may perform beamforming processing on the speech input signal generated by the microphones in the microphone array to obtain a composite signal, and the execution body may perform the beamforming processing on the speech input signal by: performing processing such as weighting, delay, and summation on the speech input signal acquired by the microphones to form a composite signal with spatial directivity, thereby accurately orienting the information source and suppressing out-of-beam sounds, such as sounds emitted by the interaction device itself. Then, the execution body may perform noise suppression processing on the composite signal. Specifically, the execution body may perform noise suppression processing on the composite signal using a commonly used filter, for example, FIR, IIR, etc. The execution body may alternatively perform noise suppression processing on the composite signal based on a noise signal frequency, a noise signal strength, a noise signal duration, etc. Then, the execution body may perform de-reverberation processing and speech enhancement processing on the signal on which the noise suppression processing is performed to obtain the target speech signal sent by the user. The execution body may adopt the existing de-reverberation technology, for example, the cepstrum de-reverberation technology, the sub-band processing method, etc., to perform de-reverberation processing on the signal on which the noise suppression processing is performed. The execution body may perform speech enhancement processing on the signal on which the noise suppression processing is performed by using the AGC (Automatic Gain Control) circuit.

Step 203 includes sending the target speech signal to a target speech processing terminal.

In the present embodiment, the execution body may send the target speech signal to the target speech processing terminal, and the target speech processing terminal is generally a speech processing terminal that establishes a connection relationship with the execution body. The target speech processing terminal may analyze the received target speech signal to obtain an analysis result, and analyzing the target speech signal includes, but is not limited to at least one of the following: performing a speech recognition and semantic understanding on the target speech signal, or the like. In the speech recognition process, the target speech processing terminal may perform steps of feature extraction, speech decoding, and text transformation on the target speech signal. In the semantic understanding process, the target speech processing terminal may perform natural language understanding (NLU), keyword extraction, and user intention analysis using an artificial intelligence (AI) algorithm on text information obtained by the speech recognition. User intention may refer to one or more objectives that the user wants to achieve. Semantic understanding technology may include steps such as field analysis, intention recognition, and word slot filling. Field analysis refers to analyzing the type to which text that is converted by speech recognition belongs, such as weather, and music. Intention recognition refers to the operation on field data, generally named after a verb-object phrase, such as asking the weather, and searching for music. Word slot filling is used to store attributes of the field, such as date or whether in the weather field, singer or name of the song in the music field. The text formed by filling the word slot may be used as the analysis result.

It should be noted that the above speech feature extraction, speech decoding technology, text transformation, keyword extraction, and artificial intelligence algorithm are well-known technologies widely studied and applied at present, and detailed description thereof will be omitted here.

In the present embodiment, the target speech processing terminal may perform an operation related to the above analysis result. If the user intention indicated by the above analysis result is that the user wants to query one or more pieces of information, the analysis result may include user query information. The target speech processing terminal may generate speech synthesis information based on the user query information. Specifically, the target speech processing terminal may send the analyzed user query information to a query server, and receive a query result for the user query information returned by the query server, and then use the text to speech technology (TTS, Text To Speech) to convert the query result into a query result in a speech form to obtain the speech synthesis information. Then, the speech synthesis information may be sent to the execution body. As an example, if the user intention indicated by the analysis result is to query the weather condition in Beijing today, the target speech processing terminal may send a query request for querying the weather condition in Beijing today to the query server. The received query result returned by the query server is “sunny, 17-25 degrees”, then, the query result “sunny, 17-25 degrees” may be converted into a query result in the speech form by using the text to speech technology to obtain the speech synthesis information.

In the present embodiment, if the analysis result includes a device identifier of a command execution device and the control command for the command execution device, the target speech processing terminal may send the control command to the command execution device indicated by the device identifier. The command execution device may perform an operation related to the above control command after receiving the control command. It should be noted that the command execution device may be a smart home device in the same local area network as the target speech processing terminal, for example, a smart TV, a smart curtain, a smart refrigerator, or the like. As an example, if the analysis result includes the device identifier “TV 001” and the control command “power on”, the target speech processing terminal may send the control command “power on” to the TV terminal with the device identifier “TV 001”. After receiving the control command “power on”, the TV terminal may perform a power-on operation.

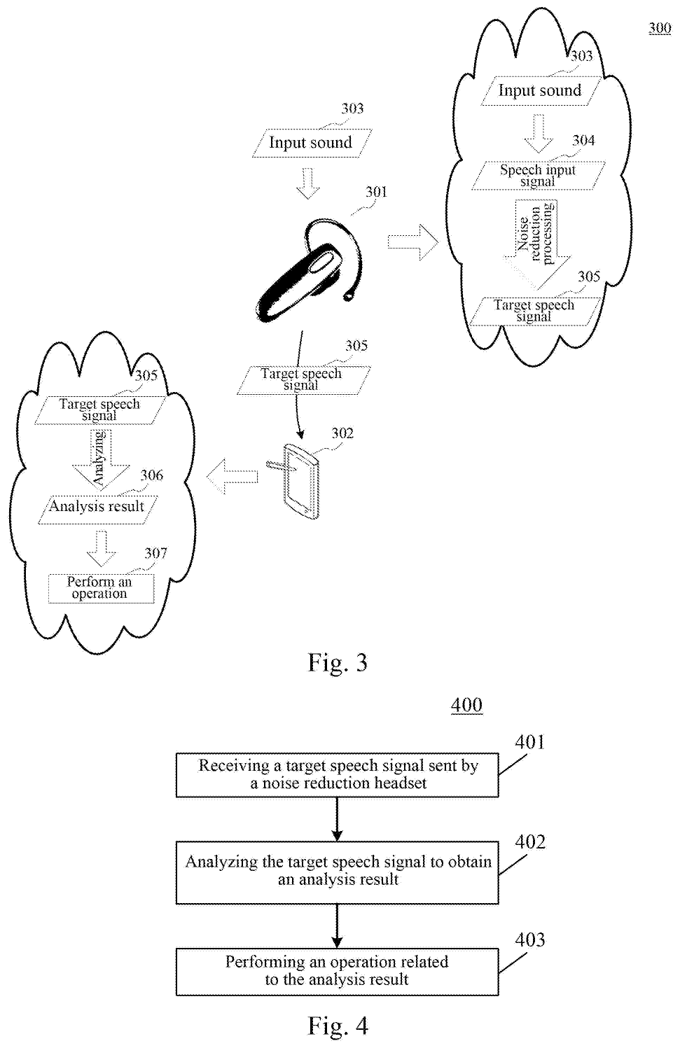

With further reference to FIG. 3, FIG. 3 is a schematic diagram of an application scenario of the method for speech interaction according to the present embodiment. In the application scenario of FIG. 3, the noise reduction headset 301 may first receive the input sound 303, for example, “close the living room curtain”, and based on the input sound 303, the noise reduction headset 301 may generate the speech input signal 304. Then, noise reduction processing may be performed on the speech input signal 304 using a commonly used digital filter such as FIR or IIR to extract the target speech signal 305 sent by the user. Then, the noise reduction headset 301 may send the target speech signal 305 to the target speech processing terminal 302. The target speech processing terminal 302 may perform processing such as speech recognition, and semantic understanding on the target speech signal 305 to obtain the analysis result 306. The analysis result 306 includes the device identifier “curtain 003” and the control command “close”. The target speech processing terminal 302 performs the operation 307 related to the analysis result 306, for example, the control command “close” may be sent to the curtain controller with the device identifier “curtain 003”, after receiving the control command “close”, the curtain controller may perform a closing operation.

The method provided by the above embodiment of the present disclosure performs noise reduction on the generated speech signal at the noise reduction headset end to extract the target speech signal sent by the user, and sends the target speech signal to the speech processing terminal for analyzing to perform the corresponding operation. The method for speech interaction may improve the noise reduction rate for the speech signal and further improve the accuracy of the operation execution.

With further reference to FIG. 4, a flow 400 of another embodiment of a method for speech interaction according to the present disclosure is illustrated. The method for speech interaction includes steps 401 to 403.

Step 401 includes receiving a target speech signal sent by a noise reduction headset.

In the present embodiment, an execution body (for example, the speech processing terminal as shown in FIG. 1) of the method for speech interaction may receive the target speech signal sent by the noise reduction headset. The noise reduction headset may first generate a speech input signal based on an input sound. Sound generally refers to sound waves generated by vibration of an object. The above input sound may be currently acquired sound, may include a user voice and an ambient sound, and the ambient sound is generally noise. When the input sound is transmitted to the vicinity of the noise reduction headset, the vibrating diaphragm in the microphone of the noise reduction headset vibrates along with the sound waves, and the vibration of the vibrating diaphragm moves the magnet inside to form a varying current, thereby generating an analog electric signal. The generated analog electric signal is an audio signal, which refers to an information carrier of a frequency and amplitude change of regular sound waves with speech, music and sound effects. Then, the noise reduction headset may perform sampling processing on the audio signal to obtain the speech input signal. The noise reduction headset may perform noise reduction processing on the generated speech input signal to extract the target speech signal sent by a user. The noise reduction headset may use a commonly used digital filter, for example, FIR, IIR, etc. to perform noise reduction processing on the speech input signal to extract the target speech signal sent by the user.

Step 402 includes analyzing the target speech signal to obtain an analysis result.

In the present embodiment, the execution body may analyze the target speech signal to obtain an analysis result, and analyzing the target speech signal includes, but is not limited to at least one of the following: performing speech recognition and semantic understanding or the like on the target speech signal. In the speech recognition process, the execution body may perform steps of feature extraction, speech decoding, and text transformation on the target speech signal. In the semantic understanding process, the execution body may perform natural language understanding, keyword extraction, and user intention analysis using an artificial intelligence algorithm on text information obtained by the speech recognition. User intention may refer to one or more objectives that the user wants to achieve.

It should be noted that the above speech feature extraction, speech decoding technology, text transformation, keyword extraction, and artificial intelligence algorithm are well-known technologies widely studied and applied at present, and detailed description thereof will be omitted.

Step 403 includes performing an operation related to the analysis result.

In the present embodiment, the execution body may perform the operation related to the above analysis result. If the user intention indicated by the above analysis result is that the user wants to query one or more pieces of information, the analysis result may include user query information. The execution body may generate speech synthesis information based on the user query information. Specifically, the execution body may send the user query information to a query server, receive a query result for the user query information returned by the query server, and then use the text to speech technology to convert the query result into a query result in a speech form to obtain the speech synthesis information. Then, the speech synthesis information may be sent to the noise reduction headset. As an example, if the user intention indicated by the analysis result is to query the weather condition in Beijing today, the execution body may send a query request for querying the weather condition in Beijing today to the query server. The received query result returned by the query server is “sunny, 17-25 degrees”, then, the query result “sunny, 17-25 degrees” may be converted into a speech form query result by using the text to speech technology to obtain the speech synthesis information.

The method provided by the above embodiment of the present disclosure obtains the analysis result by analyzing the target speech signal sent by the noise reduction headset, where the target speech signal is obtained by the noise reduction headset through performing noise reduction processing on the speech input signal generated based on the input sound, and then an operation related to the analysis result is performed. This method for speech interaction may improve the noise reduction rate for the speech signal and further improve the accuracy of the operation execution.

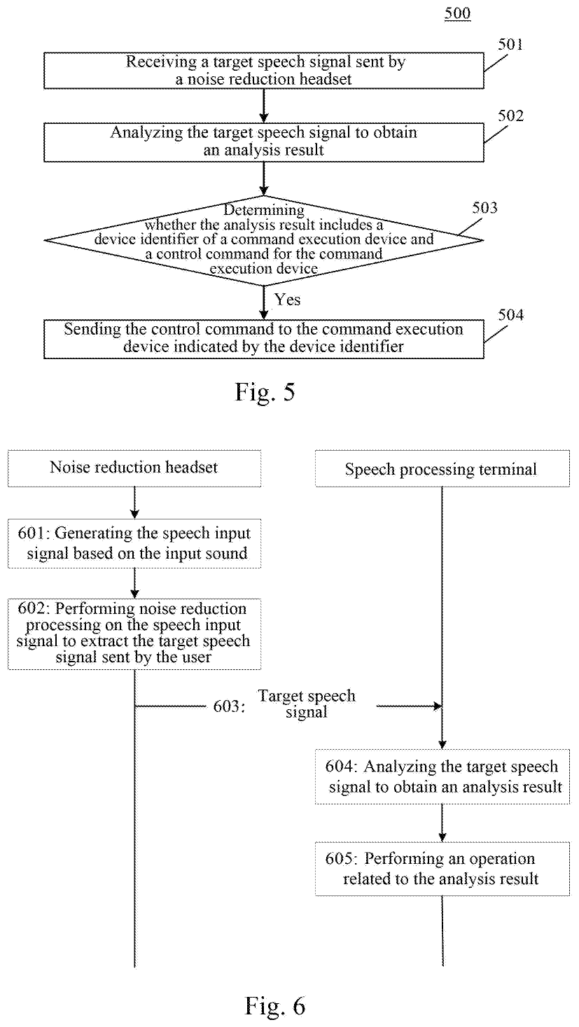

With further reference to FIG. 5, a flow 500 of another embodiment of the method for speech interaction according to the present disclosure is illustrated. The method for speech interaction includes steps 501 to 504.

Step 501 includes receiving a target speech signal sent by a noise reduction headset.

In the present embodiment, the operation of step 501 is substantially the same as the operation of step 401, and detailed description thereof is omitted.

Step 502 includes analyzing the target speech signal to obtain an analysis result.

In the present embodiment, the operation of step 502 is substantially the same as the operation of step 402, and detailed description thereof is omitted.

Step 503 includes determining whether the analysis result includes a device identifier of a command execution device and a control command for the command execution device.

In the present embodiment, the execution body may determine whether the analysis result obtained in step 502 includes the device identifier of the command execution device and the control command for the command execution device. The device identifier of the command execution device may be a name of the command execution device or a preset serial number of the command execution device or a combination of the device name and the device serial number of the command execution device, for example, the device identifiers of two TV terminals in a smart home system may be “TV 001” and “TV 002” respectively, and the corresponding relationships between the device identifiers “TV 001” and “TV 002” and the two TV terminals needs to be set in advance. The command execution device maybe a smart home device located in the same local area network as the execution body, for example, a smart TV, a smart curtain, a smart refrigerator, and the like.

Step 504 includes sending the control command to the command execution device indicated by the device identifier, in response to determining that the analysis result includes the device identifier of the command execution device and the control command for the command execution device.

In the present embodiment, if it is determined in step 503 that the analysis result includes the device identifier of the command execution device and the control command for the command execution device, the execution entity may send the control command to the command execution device indicated by the device identifier, and the command execution device may perform the operation related to the control command after receiving the control command. As an example, if the analysis result includes the device identifier “TV 001” and the control command “power on”, the execution body may send the control command “power on” to the TV terminal with the device identifier “TV 001”. After receiving the control command “power on”, the TV terminal may perform a power-on operation.

As shown in FIG. 5, compared with the embodiment corresponding to FIG. 4, the flow 500 of the method for speech interaction in the present embodiment adds the step 503 of determining whether the device identifier of the command execution device and the control command for the command execution device are included in the analysis result, and the step 504 of sending the control command to the command execution device indicated by the device identifier, in response to determining that the analysis result includes the device identifier of the command execution device and the control command for the command execution device. Therefore, in the process of speech interaction between the user and a far-field speech device, the solution described by the present embodiment, rather than requiring the user to wake up the far-field speech device every time by speaking a wake-up word, performs speech interaction with the far-field speech device by means of the noise reduction headset, thereby simplifying the operation steps of the user.

FIG. 6 is a timing diagram of an embodiment of a system for speech interaction according to the present disclosure.

The system for speech interaction according to the present embodiment includes: a speech processing terminal and a noise reduction headset. The noise reduction headset is configured to generate a speech input signal based on an input sound, perform noise reduction processing on the speech input signal to extract a target speech signal sent by a user, and send the target speech signal to the speech processing terminal, the input sound including a user voice and an ambient sound. The speech processing terminal is configured to analyze the target speech signal to obtain an analysis result, and perform an operation related to the analysis result.

In the system for speech interaction provided by the present embodiment, the noise reduction headset generates a speech input signal based on an input sound, then performs noise reduction processing on the speech input signal to extract a target speech signal sent by a user, and sends the target speech signal to the speech processing terminal, so that the speech processing terminal analyzes the target speech signal to obtain an analysis result, and performs an operation related to the analysis result. Therefore, the acquired speech signal may be denoised at the noise reduction headset end to extract the target speech signal sent by the user, and the target speech signal is sent to the speech processing terminal for analysis to perform a corresponding operation. This method for speech interaction may improve the noise reduction rate for the speech signal and further improve the accuracy of the operation execution.

In some alternative implementations of the present embodiment, the system for speech interaction may further include a command execution device, where the command execution device may be configured to perform an operation related to the received control command.

As shown in FIG. 6, in step 601, the noise reduction headset generates the speech input signal based on the input sound.

Here, the noise reduction headset may generate the speech input signal based on the input sound. Sound generally refers to sound waves generated by vibration of an object. The above input sound may be currently acquired sound, may include a user voice and an ambient sound, and the ambient sound is generally noise. When the input sound is transmitted to the vicinity of the noise reduction headset, the vibrating diaphragm in the microphone of the noise reduction headset vibrates along with the sound waves, and the vibration of the vibrating diaphragm moves the magnet inside to form a varying current, thereby generating an analog electric signal. The generated analog electric signal is an audio signal, which refers to an information carrier of frequency and amplitude change of regular sound waves with speech, music and sound effects. Then, the noise reduction headset may perform sampling processing on the audio signal to obtain the speech input signal.

In step 602, the noise reduction headset performs noise reduction processing on the speech input signal to extract the target speech signal sent by the user.

Here, the noise reduction headset may perform noise reduction processing on the generated speech input signal to extract the target speech signal sent by the user. The noise reduction headset may use a commonly used digital filter, for example, FIR, IIR, etc. to perform noise reduction processing on the speech input signal to extract the target speech signal sent by the user.

In some alternative implementations of the present embodiment, a microphone array may be installed in the noise reduction headset. The microphone array is generally a system composed of a certain number of acoustic sensors (generally microphones) for sampling and processing spatial characteristics of the sound field. The use of the microphone array for the acquisition of the speech signal may utilize the difference between the phases of sound waves received by a plurality of microphones to filter the sound waves, thereby maximally removing the ambient background sound to achieve the effect of noise reduction. The noise reduction headset may perform beamforming processing on the speech input signal generated by the microphones in the microphone array to obtain a composite signal, and the noise reduction headset may perform beamforming processing on the speech input signal as follows: performing processing such as weighting, delay, and summation on the speech input signal acquired by the microphones to form a composite signal with spatial directivity, thereby accurately orienting the information source and suppressing out-of-beam sounds, such as sounds emitted by the interaction device itself. Then, the noise reduction headset may perform noise suppression processing on the composite signal. Specifically, the noise reduction headset may perform noise suppression processing on the composite signal using a commonly used filter, for example, FIR, IIR, etc. The noise reduction headset may also perform noise suppression processing on the composite signal based on a noise signal frequency, a noise signal strength, a noise signal duration, etc. Then, the noise reduction headset may perform de-reverberation processing and speech enhancement processing on the signal to which the noise suppression processing is performed to obtain the target speech signal sent by the user. The noise reduction headset may adopt the existing de-reverberation technology, for example, the cepstrum de-reverberation technology, the sub-band processing method, etc., to perform de-reverberation processing on the signal to which the noise suppression processing is performed. The noise reduction headset may perform speech enhancement processing on the signal to which the noise suppression processing is performed by using the AGC circuit.

In step 603, the noise reduction headset sends the target speech signal to the speech processing terminal.

Here, the noise reduction headset may send the target speech signal to a target speech processing terminal, and the target speech processing terminal is generally a speech processing terminal that establishes a connection relationship with the execution body.

In step 604, the speech processing terminal analyzes the target speech signal to obtain an analysis result.

Here, the speech processing terminal may analyze the received target speech signal to obtain the analysis result, and analyzing the target speech signal includes, but is not limited to at least one of the following: performing a speech recognition and semantic understanding, or the like on the target speech signal. In the speech recognition process, the speech processing terminal may perform steps of feature extraction, speech decoding, and text transformation on the target speech signal. In the semantic understanding process, the speech processing terminal may perform natural language understanding, keyword extraction, and user intention analysis using an artificial intelligence on text information obtained by the speech recognition. User intention may refer to one or more objectives that the user wants to achieve.

It should be noted that the above speech feature extraction, speech decoding technology, text transformation, keyword extraction, and artificial intelligence algorithm are well-known technologies widely studied and applied at present, and detailed description thereof will be omitted here.

In step 605, the speech processing terminal performs an operation related to the analysis result.

Here, the speech processing terminal may perform the operation related to the above analysis result. If the user intention indicated by the above analysis result is that the user wants to query one or more pieces of information, the analysis result may include user query information. The speech processing terminal may generate speech synthesis information based on the user query information. Specifically, the speech processing terminal may send the analyzed user query information to a query server, receive a query result returned by the query server for the user query information, and then use the text to speech technology to convert the query result into a query result in a speech form to obtain the speech synthesis information. Then, the speech synthesis information may be sent to the noise reduction headset. As an example, if the user intention indicated by the analysis result is to query the weather condition in Beijing today, the speech processing terminal may send a query request for querying the weather condition in Beijing today to the query server. The received query result returned by the query server is “sunny, 17-25 degrees”, then, the query result “sunny, 17-25 degrees” may be converted into a query result in the speech form by using the text to speech technology to obtain the speech synthesis information.

In some alternative implementations of the present embodiment, the speech processing terminal may determine whether the analysis result includes a device identifier of a command execution device and a control command for the command execution device. The command execution device may be a smart home device in the same local area network as the execution body, for example, a smart TV, a smart curtain, a smart refrigerator, and the like. If the speech processing terminal determines that the device identifier of the command execution device and the control command for the command execution device are included in the analysis result, the control command may be sent to the command execution device indicated by the device identifier. The command execution device may perform the operation related to the control command after receiving the control command. As an example, if the analysis result includes the device identifier “TV 001” and the control command “power on”, the speech processing terminal may send the control command “power on” to the TV terminal with the device identifier “TV 001”. After receiving the control command “power on”, the TV terminal may perform a power-on operation.

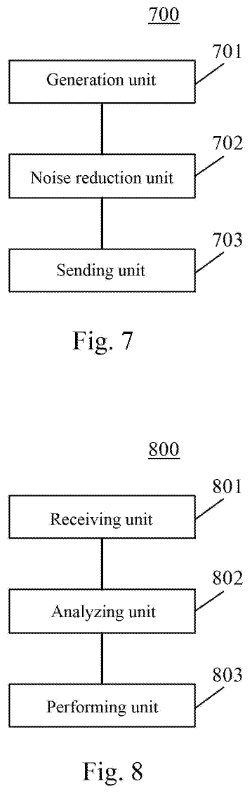

With further reference to FIG. 7, as an implementation to the method shown in the above figures, the present disclosure provides an embodiment of an apparatus for speech interaction. The apparatus embodiment corresponds to the method embodiment shown in FIG. 2, and the apparatus may specifically be applied to various electronic devices.

As shown in FIG. 7, the apparatus 700 for speech interaction of the present embodiment includes: a generation unit 701, a noise reduction unit 702 and a sending unit 703. The generation unit 701 is configured to generate a speech input signal based on an input sound, the input sound including a user voice and an ambient sound. The noise reduction unit 702 is configured to perform noise reduction processing on the speech input signal to extract a target speech signal sent by a user. The sending unit 703 is configured to send the target speech signal to a target speech processing terminal, the target speech processing terminal analyzing the target speech signal to obtain an analysis result, and performing an operation related to the analysis result.

In the present embodiment, the specific processing of the generation unit 701, the noise reduction unit 702, and the sending unit 703 of the apparatus 700 for speech interaction may refer to step 201, step 202, and step 203 in the corresponding embodiment of FIG. 2.

In some alternative implementations of the present embodiment, the generation unit 701 may convert the input sound into an audio signal. The vibrating diaphragm in the microphone of the execution body vibrates along with the sound waves, and the vibration of the vibrating diaphragm moves the magnet inside to form a varying current, thereby generating an analog electric signal, and the generated analog electric signal is the audio signal; then, the execution body may sample the audio signal at a preset first sampling rate to obtain the speech input signal. The sampling rate, also known as the sampling speed or sampling frequency, defines the number of samples that are extracted from a continuous signal and form discrete signals per second. The obtained speech input signal needs to be sent to the target speech processing terminal for processing such as a speech recognition, and generally the speech recognition has a good effect when performed by the target speech processing terminal on the digital signal obtained by sampling at a sampling rate of 16 kilohertz (kHz). Thus, generally the first sampling rate may be set to 16 kHz, or may be set to other sampling rates with which a predetermined speech recognition effect can be achieved.

In some alternative implementations of the present embodiment, the noise reduction unit 702 may perform beamforming processing on the speech input signal generated by the microphones in the microphone array to obtain a composite signal, and the noise reduction unit 702 may perform the beamforming processing on the speech input signal by: performing weighting, delay, and summation processing on the speech input signal acquired by the microphones to form a composite signal with spatial directivity, thereby accurately orienting the information source and suppressing out-of-beam sounds, such as sounds emitted by the interaction device itself. Then, the noise reduction unit 702 may perform noise suppression processing on the composite signal. Specifically, the noise reduction unit 702 may perform noise suppression processing on the composite signal using a commonly used filter, for example, FIR, IIR, etc. The noise reduction unit 702 may also perform noise suppression processing on the composite signal based on a noise signal frequency, a noise signal strength, a noise signal duration, etc. Then, the noise reduction unit 702 may perform de-reverberation processing and speech enhancement processing on the signal to which the noise suppression processing is performed to obtain the target speech signal sent by the user. The noise reduction unit 702 may adopt the existing de-reverberation technology, for example, the cepstrum de-reverberation technology, the sub-band processing method, etc., to perform de-reverberation processing on the signal to which the noise suppression processing is performed. The noise reduction unit 702 may perform speech enhancement processing on the signal to which the noise suppression processing is performed by using the AGC circuit.

In some alternative implementations of the present embodiment, the apparatus 700 for speech interaction may further include an establishing unit (not shown in the figure). The establishing unit may receive a pairing request of the speech processing terminal, and if the pairing request of the speech processing terminal is received, a pairing relationship with the target speech processing terminal may be established. The speech processing terminal that establishes the pairing relationship with the execution body may be determined as the target speech processing terminal. After the pairing is successful, the execution body may be used as a microphone peripheral of the target speech processing terminal.

With further reference to FIG. 8, as an implementation to the method shown in the above figures, the present disclosure provides another embodiment of an apparatus for speech interaction. The apparatus embodiment corresponds to the method embodiment shown in FIG. 4, and the apparatus may specifically be applied to various electronic devices.

As shown in FIG. 8, the apparatus 800 for speech interaction of the present embodiment includes: a receiving unit 801, an analyzing unit 802 and a performing unit 803. Here, the receiving unit 801 is configured to receive a target speech signal sent by a noise reduction headset, the target speech signal being a speech signal sent by a user and extracted by the noise reduction headset through performing noise reduction processing on a speech input signal, and the speech input signal being generated based on an input sound. The analyzing unit 802 is configured to analyze the target speech signal to obtain an analysis result. The performing unit 803 is configured to perform an operation related to the analysis result.

In the present embodiment, the specific processing of the receiving unit 801, the analyzing unit 802 and the performing unit 803 of the apparatus 800 for speech interaction may refer to step 401, step 402, and step 403 in the corresponding embodiment of FIG. 4.

In some alternative implementations of the present embodiment, the performing unit 803 may determine whether the analysis result includes the device identifier of a command execution device and a control command for the command execution device. The command execution device may be a smart home device in the same local area network as the execution body, for example, a smart TV, a smart curtain, a smart refrigerator, or the like. If the performing unit 803 determines that the analysis result includes the device identifier of the command execution device and the control command for the command execution device, the performing unit 803 may send the control command to the command execution device indicated by the device identifier. The command execution device may perform an operation related to the above control command after receiving the control command. As an example, if the analysis result includes the device identifier “TV001” and the control command “power on”, the performing unit 803 may send the control command “power on” to the TV terminal with the device identifier “TV001”. After receiving the control command “power on”, the TV terminal may perform a power-on operation.

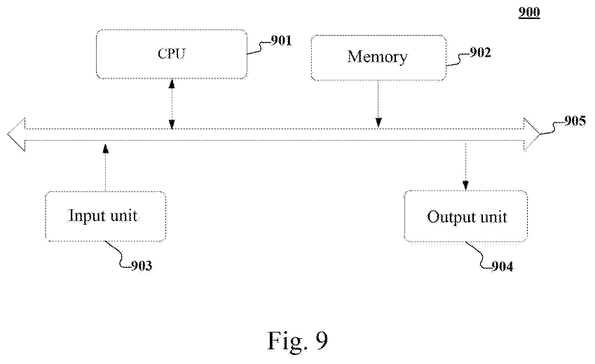

Referring to FIG. 9, a schematic structural diagram of a computer system 900 adapted to implement an electronic device (e.g., noise reduction headset) of the embodiments of the present disclosure is shown. The electronic device shown in FIG. 9 is only an example, and should not limit a function and scope of the embodiment of the disclosure.

As shown in FIG. 9, the computer system 900 includes a central processing unit (CPU) 901, a memory 902, an input unit 903 and an output unit 904. The CUP 901, the memory 902, the input unit 903 and the output unit 904 are connected with each other through a bus. Here, the method according to an embodiment of the present application may be implemented as a computer program and stored in the memory 902. The CPU 901 in the electronic device 900 specifically implements the voice interaction function defined in the method of the embodiment of the present disclosure by invoking the above-mentioned computer program stored in the memory 902. In some implementations, the input unit 903 may be a device that can be used to receive input sound, such as a microphone, and the output unit 904 may be a device that can be used to play sound, such as a speaker. Thus, the CPU 901 can control the input unit 903 to receive sound from the outside when the computer program is invoked to execute the voice interactive function, and control the output unit 904 to play the sound.

In particular, according to embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for executing the method as illustrated in the flow chart. The computer program, when executed by the central processing unit (CPU) 901, implements the above mentioned functionalities as defined by the methods of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, described as: a processor, including a generation unit, a noise reduction unit and a sending unit, where the names of these units do not in some cases constitute a limitation to such units themselves. For example, the generation unit may also be described as “a unit for generating a speech input signal based on an input sound.”

In another aspect, the present disclosure further provides a computer-readable medium. The computer-readable medium may be the computer-readable medium included in the apparatus in the above described embodiments, or a stand-alone computer-readable medium not assembled into the apparatus. The computer-readable medium stores one or more programs. The one or more programs, when executed by a device, cause the device to: generate a speech input signal based on an input sound, the input sound including a user voice and an ambient sound; perform noise reduction processing on the speech input signal to extract a target speech signal sent by a user; and send the target speech signal to a target speech processing terminal, the target speech processing terminal analyzing the target speech signal to obtain an analysis result, and performing an operation related to the analysis result.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for speech interaction, the method comprising:
generating a speech input signal based on an input sound, the input sound comprising a user voice and an ambient sound;
performing noise reduction processing on the speech input signal to extract a target speech signal sent by a user; and
sending the target speech signal to a target speech processing terminal, the target speech processing terminal analyzing the target speech signal to obtain an analysis result, and performing an operation related to the analysis result.

2. The method according to claim 1, wherein the generating a speech input signal based on an input sound comprises:
converting the input sound into an audio signal; and
sampling the audio signal at a preset first sampling rate to obtain the speech input signal.

3. The method according to claim 1, wherein the performing noise reduction processing on the speech input signal to extract a target speech signal sent by a user comprises:
performing beamforming processing on the speech input signal to obtain a composite signal;
performing noise suppression processing on the composite signal; and
performing de-reverberation processing and speech enhancement processing on the signal to which the noise suppression processing is performed to obtain the target speech signal sent by the user.

4. The method according to claim 1, wherein, before the generating a speech input signal based on an input sound, the method further comprising:
establishing a pairing relationship with the target speech processing terminal, in response to receiving a pairing request sent by the target speech processing terminal.

5. An apparatus for speech interaction, the apparatus comprising:
at least one processor; and
a memory storing instructions, wherein the instructions when executed by the at least one processor, cause the at least one processor to perform operations, the operations comprising:
generating a speech input signal based on an input sound, the input sound comprising a user voice and an ambient sound;
performing noise reduction processing on the speech input signal to extract a target speech signal sent by a user; and
sending the target speech signal to a target speech processing terminal, the target speech processing terminal analyzing the target speech signal to obtain an analysis result, and performing an operation related to the analysis result.

6. The apparatus according to claim 5, wherein the generating a speech input signal based on an input sound comprises:
converting the input sound into an audio signal; and
sampling the audio signal at a preset first sampling rate to obtain the speech input signal.

7. The apparatus according to claim 5, wherein the performing noise reduction processing on the speech input signal to extract a target speech signal sent by a user comprises:
performing beamforming processing on the speech input signal to obtain a composite signal;
performing noise suppression processing on the composite signal; and
performing de-reverberation processing and speech enhancement processing on the signal to which the noise suppression processing is performed to obtain the target speech signal sent by the user.

8. The apparatus according to claim 5, wherein the operations further comprise:
establishing a pairing relationship with the target speech processing terminal, in response to receiving a pairing request sent by the target speech processing terminal.

9. A method for speech interaction, the method comprising:
receiving a target speech signal sent by a noise reduction headset, the target speech signal being a speech signal sent by a user and extracted by the noise reduction headset through performing noise reduction processing on a speech input signal, and the speech input signal being generated based on an input sound;
analyzing the target speech signal to obtain an analysis result; and
performing an operation related to the analysis result.

10. The method according to claim 9, wherein the performing an operation related to the analysis result comprises:
sending a control command to a command execution device indicated by a device identifier for the command execution device to perform an operation related to the control command, in response to determining that the analysis result comprises the device identifier of the command execution device and the control command for the command execution device.

11. An apparatus for speech interaction, the apparatus comprising:
at least one processor; and
a memory storing instructions, wherein the instructions when executed by the at least one processor, cause the at least one processor to perform operations, the operations comprising:
receiving a target speech signal sent by a noise reduction headset, the target speech signal being a speech signal sent by a user and extracted by the noise reduction headset through performing noise reduction processing on a speech input signal, and the speech input signal being generated based on an input sound;
analyzing the target speech signal to obtain an analysis result; and
performing an operation related to the analysis result.

12. The apparatus according to claim 11, wherein the performing an operation related to the analysis result comprises:
sending a control command to a command execution device indicated by a device identifier for the command execution device to perform an operation related to the control command, in response to determining that the analysis result comprises the device identifier of the command execution device and the control command for the command execution device.

13. A system for speech interaction, the system comprising:
a noise reduction headset, configured to generate a speech input signal based on an input sound, perform noise reduction processing on the speech input signal to extract a target speech signal sent by a user, and send the target speech signal to a speech processing terminal, the input sound comprising a user voice and an ambient sound; and
the speech processing terminal, configured to analyze the target speech signal to obtain an analysis result, and perform an operation related to the analysis result.

14. The system according to claim 13, wherein,
the noise reduction headset, is configured to convert the input sound into an audio signal, and sample the audio signal at a preset first sampling rate to obtain the speech input signal.

15. The system according to claim 13, wherein,
the noise reduction headset, is configured to perform beamforming processing on the speech input signal to obtain a composite signal, perform noise suppression processing on the composite signal, and perform de-reverberation processing and speech enhancement processing on the signal to which the noise suppression processing is performed to obtain the target speech signal sent by the user.

16. The system according to claim 13, wherein,
the speech processing terminal, is configured to send a pairing request to the noise reduction headset; and
the noise reduction headset, is configured to establish a pairing relationship with the speech processing terminal.

17. The system according to claim 13, wherein the system further comprises a command execution device;
the speech processing terminal, is configured to send a control command to a command execution device, in response to determining that the analysis result comprises a device identifier of the command execution device and a control command for the command execution device; and
the command execution device, is configured to perform an operation related to the control command.

18. A non-transitory computer medium, storing a computer program thereon, the program, when executed by a processor, implements the method according to claim 1.

19. A non-transitory computer medium, storing a computer program thereon, the program, when executed by a processor, implements the method according to claim 9.
